(19) United States
(12) Patent Application Publication
(10) Pub. No.: US 2006/0224280 A1
(43) Pub. Date: Oct. 5, 2006

(54) Remote vehicle control systems

(76) Inventors: Thomas C. Flanigan, Vienna, VA (US); Thaddeus N. Selden, Arlington, VA (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 11/096,288

(22) Filed: Apr. 1, 2005

(51) Int. Cl. G06F 19/00

(52) U.S. Cl. 701/2; 701/1; 701/50

(57) ABSTRACT

A remote control system for remotely controlling a vehicle includes a pair of hand controls to be engaged by hands of a user. The hand controls may be moveable in order to cause movement of the overall vehicle and accessories of the vehicle. Numerous switches on the hand controls may be operable for other purposes, such as operating cameras on the vehicle, while the user maintains a gripping or other physical engagement with the hand controls. There may be buttons or switches corresponding to a number of preset positions for the one or more cameras. The additional controls may include an actuatable switch, such as a slider, to control sensitivity of inputs provided by moving the hand controls. The remote control system allows precise remote control, with visual feedback, of vehicles in any of a wide variety of situations.

### BACKGROUND OF THE INVENTION

1. Technical Field of the Invention

The invention relates to systems for remotely controlling a vehicle, such as a land or sea vehicle.

2. Background of the Related Art

There are situations where it is advantageous to remotely operate a vehicle, without a human operator being onboard the vehicle. One example of such a situation is when handling actual or potential explosive devices. Remote control systems for such vehicles have often been awkward to operate. Accordingly, it will be appreciated that improvements in such systems would be desirable.

### SUMMARY OF THE INVENTION

According to an aspect of the invention, a remote control system for control of a vehicle allows the user to access auxiliary functions while maintaining physical contact with controls for controlling movement of the vehicle.

According to another aspect of the invention, a remote control system for control of a vehicle includes camera controls that are accessible to the hands of the operator while the operator maintains physical contact with the vehicle movement controls and controls for moving an accessory of the vehicle. The camera controls may include controls for controlling one or more of camera pan angle, camera tilt angle, and/or degree of camera zoom. The camera controls may also include (or may alternatively include) one or more controls that allow setting of one or more camera preset configurations (selecting predetermined values of camera orientation (pan and/or tilt) and/or degree of camera zoom).

According to still another aspect of the invention, a control system for remotely controlling a vehicle includes: hand controls for remotely controlling movement of the vehicle, and for controlling one or more cameras mounted on the vehicle; and a display for displaying output from the one or more cameras. The hand controls are configured to be moved to control movement of the vehicle. The hand controls include camera-control switches for controlling the one or more cameras. The hand controls are configured to receive both hands of a user. The camera-control switches are operable by the user without the user removing the hands from the hand controls.

According to a further aspect of the invention, a method of remotely controlling a vehicle, includes the steps of: controlling movement of the vehicle and one or more accessories of the vehicle using hand controls of a remote control system; and controlling positioning of one or more cameras of the vehicle using camera switches on the hand controls.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 is a schematic illustration of control of a vehicle by a remote control unit or system in accordance with the present invention;

FIG. 2 is a schematic illustration of a remote control unit in accordance with the present invention;

FIG. 3 is a back view of one of the hand controls of the remote control system of FIG. 2;

FIG. 4 is a side view of one of the hand controls of the remote control system of FIG. 2;

FIG. 5 is an illustration of one example of possible cab camera presets used with a remote control system of the present invention;

FIG. 6 is an illustration of one example of roof camera presets used with a remote control system of the present invention; and

FIG. 7 illustrates one possible view on the display of a remote control system in accordance with the present invention.

### DETAILED DESCRIPTION

A remote control system for remotely controlling a vehicle includes a pair of hand controls to be engaged by hands of a user, and a visual display that provides feedback regarding actions of the remotely-controlled vehicle. The hand controls may be moveable in order to cause movement of the overall vehicle and accessories of the vehicle. Numerous switches on the hand controls may be operable for other purposes while the user maintains a gripping or other physical engagement with the hand controls. The other controls may include switches, buttons, and/or slides, for performance of any of a wide variety of other tasks. For example, other controls may be used to control pan, tilt, and zoom functions of one or more cameras on the vehicle. There may be buttons or switches corresponding to a number of preset positions for the one or more cameras. The additional controls may include an actuatable switch, such as a slider, to control sensitivity of inputs provided by moving the hand controls. The visual display may show visual output from the one or more cameras mounted on the vehicle, as well as a wide variety of other information, such as position of vehicle accessories, position of the controllers, and status of the vehicle. By enabling a user to remotely control the vehicle without needing to remove hands from the hand controls, and without needing to shift his or her gaze from the visual display, a user may advantageously be able to remotely operate the vehicle in an efficient way, substantially intuitively controlling the remote vehicle. The remote control system allows precise remote control, with visual feedback, of vehicles in any of a wide variety of situations, including vehicles operating in dangerous environments.

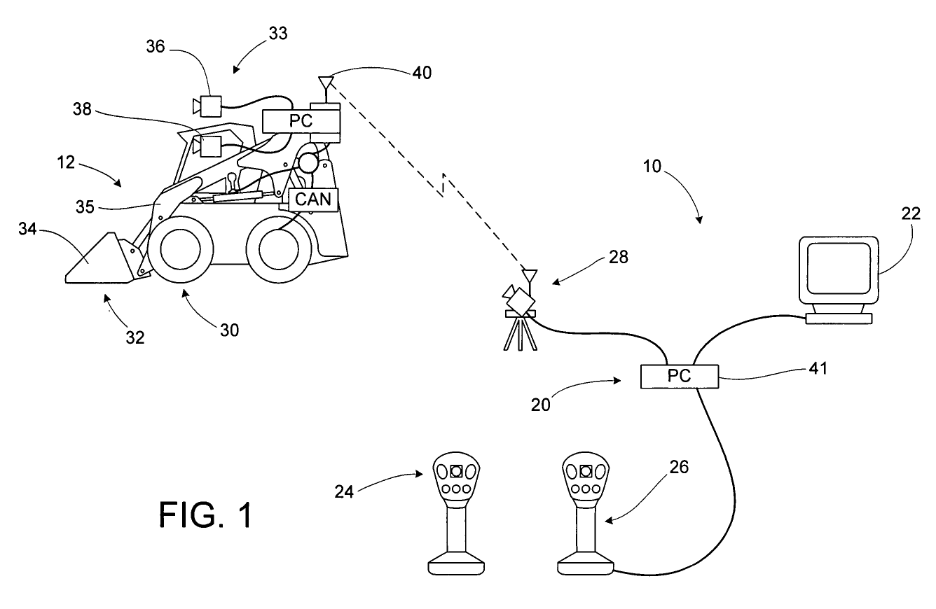

FIG. 1 illustrates a remote control unit 10 used for remotely controlling and operating a vehicle 12. A vehicle, as the term is used herein, refers to a land- or sea-based vehicle, including surface sea vehicles and underwater vehicles. Aircraft are specifically excluded from the definition of “vehicle,” although it will be appreciated that the invention may be usable with aircraft as well. The remote control unit 10 is remote from the vehicle 12 in that it is not in direct contact with the vehicle 12. The remote control unit 10 and the vehicle 12 may communicate through use of suitable signals, for instance, through use of suitable radio frequency or optical signals. Alternatively, the remote control unit 10 and the vehicle 12 may be coupled together using other sorts of connections, such as via electrical signals in a wired connection. The remote control unit 10 may be any of a wide variety of distances from the vehicle 12. For example, the remote control unit 10 may be as close as a few meters away from the vehicle 12. Alternatively, parts of the remote control unit 10 may be as far away as hundreds or thousands of kilometers from the vehicle 12. A remote unit 10 may have a local transceiver that communicates with the vehicle 12, and is suitably coupled, such as by means of a computer network, to other parts of the remote control unit 10 a great distance away.

The remote control unit 10 includes a computer 20, a display 22, a pair of hand controls 24 and 26, and a control unit transceiver 28. The computer 20, which may be a standard computer such as a personal computer, is coupled to the other components 22-28 for communicating information to and from a user of the remote control unit 10. The hand controls 24 and 26 are used to allow the user to input commands to the vehicle 12. The commands may include effecting overall movement of the vehicle 12 by a movement system 30 of the vehicle 12, moving attachments or accessories 32 of the vehicle 12, for instance to perform an operation, and/or positioning or operating sensors 33 of the vehicle 12, for instance a roof camera 36 and a cab camera 38. Information input by the user into the hand controls 24 and 26 is suitably processed by the computer 20, so that suitable signals are transmitted by the control unit transceiver 28 to a vehicle transceiver 40. Various information may be transmitted from the vehicle 12 to the remote control unit 10 via the transceiver 40. Such information may include position information regarding the overall position of the vehicle 12, the position of various parts of the attachments or accessories 32 of the vehicle 12, and images or other information received by the sensors 33. Further information regarding the status of the vehicle, such as the vehicle's speed, may also be transmitted. Information from the vehicle 12 may be processed by the computer 20, and may be visually displayed on the display 22 for use by the user or operator of the remote control system 10. Thus, the remote control system 10 allows interactive remote operation of the vehicle 12.

The vehicle 12 illustrated in FIG. 1 is a front end loader, a wheeled vehicle having a scoop or bucket 34 as a movable accessory 32, the bucket 34 being moved by movement of an attached arm 35. However, it will be appreciated that a wide variety of other types of vehicles may alternatively be used in conjunction with the remote control system 10. For example, a wide variety of different types of land vehicles, for instance wheeled or tracked vehicles, may be employed. Such vehicles may have a wide variety of movable accessories for mechanically picking up, moving, and/or actuating any of a wide variety of objects or portions of objects. Sensors may be any of a wide variety of data-gathering devices, cameras being only one example of such devices. Other possible data-gathering devices include any of a wide variety of sensors for gathering images or other information. Examples of such other sensors include laser radar (LIDAR), infrared cameras, thermal cameras, radar, and sonar.

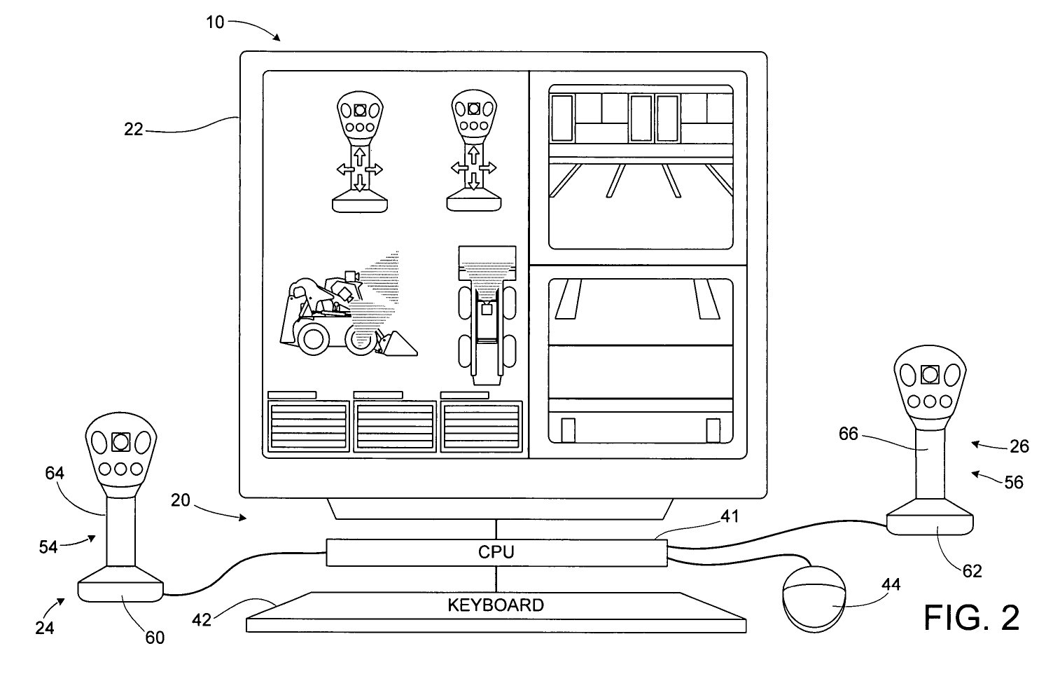

Turning now to FIG. 2, some additional details are given with regard to the remote control unit or system 10. The computer 20 includes a computer processor 41, a keyboard 42, and a mouse 44. The keyboard 42 and the mouse 44 are examples of data-entry devices that may be used to enter information or commands in order to change the information on the display 22, and/or to send commands via the remote control transceiver 28 to the vehicle 12. Other functions that may be performed using the keyboard 42 and/or the mouse 44 may include configuring the hand controls 24 and 26, and starting, stopping, and/or controlling a computer program run on the computer processor 41, which is used to control operations of the remote control unit 10. It will be appreciated that the keyboard 42 and the mouse 44 are two examples of types of data-entry devices. Other suitable types of data-entry devices, such as track balls, and touch pads, may be used alternatively or in addition. It may also be possible to use other types of controllers.

In the illustrated embodiment, the hand controls 24 and 26 are respective joystick controllers 54 and 56. The joystick controllers 54 and 56 have respective bases 60 and 62, with respective joysticks 64 and 66 movable relative to the bases 60 and 62. The joysticks 64 and 66 have various controllers (buttons, switches, and sliders), which are used to control camera movements and the input sensitivity of movement of the joysticks 64 and 66. These controllers (also referred to as switches or control switches) are described in greater detail below.

The joystick controller 54 is used for control of general motion of the vehicle 12, and for control of the cab camera 38. In controlling overall motion of the vehicle 12, the joystick 64 may be tilted forward to move the vehicle 12 forward, may be tilted backward to move the vehicle 12 backward, and may be tilted to the left or right to turn or pivot the vehicle 12.

The joystick controller 56 is used for controlling movement of the attachment 32 (the bucket 34 and the arm 35) of the vehicle 12, and for controlling operation of the roof camera 36. Tilting the joystick 66 forward lowers the attachment arm 35 of the attachment 32. Tilting the joystick 66 backwards raises the attachment arm 35 of the attachment 32. Movement of the joystick 66 to the left and right raises the bucket 32 (tilting it upward) and lowering the bucket 32 (tilting it downward, such as to dump contents of the bucket 32).

It will be appreciated that alternatively the joystick controller 54 may be used to operate the roof camera 36, and the joystick controller 56 may be used to operate the cab camera 38.

The control of movement of the vehicle 12 and the attachment 32 by tilting of the joysticks 64 and 66 may correspond to movements used by an onboard operator of the vehicle 12, to cause similar movements of the vehicle 12 and the attachment 32. This advantageously makes operation of the remote control system 10 more closely correspond to actual operation of the vehicle 12 by an onboard operator. This allows a user experienced with on-board operation of the vehicle 12 to more quickly, easily, and accurately transition to operation of the vehicle 12 by use of the remote control system 10. However, it will be appreciated that the configuration of the hand controls 24 and 26 need not necessarily correspond to the configuration and/or operation of onboard controls (if any) of the vehicle 12.

Additional operations may be accomplished by other movements of the joysticks 64 and/or 66. For instance, twisting of one or both of the joysticks 64 and 66 may be used to perform an operation in the vehicle 12 and/or the attachment 32. As one specific example, twisting of one of the joysticks 64 and 66 may be used to operate a claw on the attachment 32.

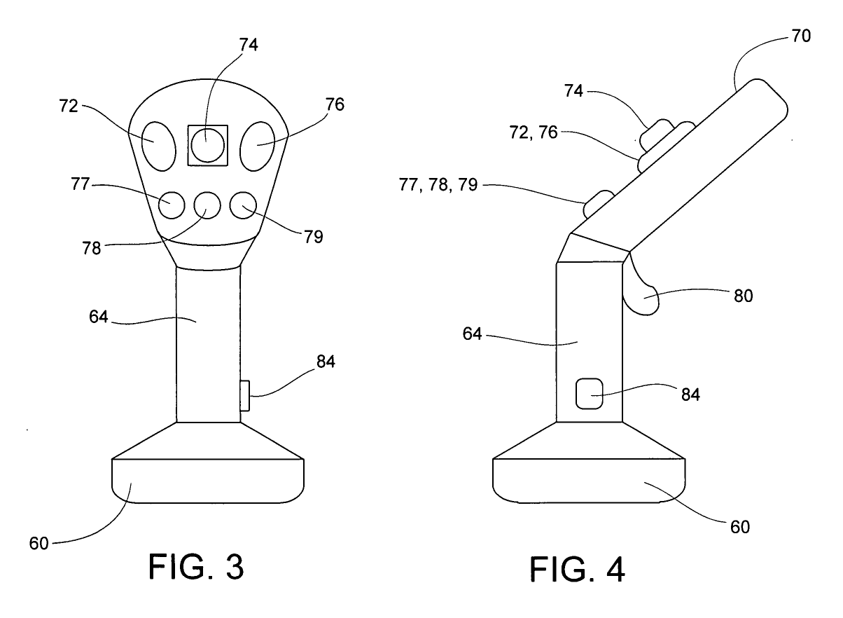

FIGS. 3 and 4 illustrate the control switches of the joystick controller 54. Similar switches with similar functions, may be provided on the joystick controller 56. On a top surface 70 of the joystick 64, there are a number of thumb-operated control switches. Among these are the camera zoom-in button or rocker switch 72, a camera pan-and-tilt hat switch 74, a camera zoom-out button or rocker switch 76, and three camera preset buttons 77-79. These switches control operation of the cab camera 38. The camera zoom-in button 72 may be actuated to zoom in the cab camera 38, with the camera zoom-out button 76 may be actuatable zoom out the cab camera 38. The hat switch 74 may be moved to the left or the right to pan left or right with the cab camera 38, and may be moved forward and backward to tilt down and tilt up the cab camera 38. The camera preset buttons 77-79 is used to move the cab camera 38 to one of a number of predetermined preset views (combinations of pan angle, tilt angle, and degree of zoom). All of the camera-control switches 72-79 are operable by the user while the user maintains a hand grip on the joystick 64. While gripping the joystick 64 with his or her hand, the operator may use his or her thumb to actuate any of the camera-control switches 72-79. It will be appreciated that such hands-on use of the switches allows the user or operator to maintain focus on the display 22 while still manipulating the full range of controls found in the hand controls 24 and 26. The user's attention is not diverted to visually finding the desired switch, actuating that switch, and then visually guiding the hand back to the joystick 64. It will be appreciated that better and more accurate control of the vehicle 12 and its accessories 32 may be maintained when the user's visual faculties are not diverted to such tasks as finding and operating controls.

Additional controls on the joystick 64 include a trigger 80 and a movement throttle slider 84. The trigger 80 may be actuated by a finger of the operator, such as the index finger, in order to engage an additional function. For example, depression of the trigger 80 may enable a faster rate of camera control utilizing the camera zoom buttons 72 and 76, and/or the camera pan-and-tilt hat switch 74. In addition, depressing the trigger 80 before pressing one of the camera preset buttons 77-79 may allow access to another set of camera presets. Alternatively, the control system 10 may be configured such that the trigger 80 engages an independent function.

The movement throttle slider 84 controls sensitivity of movement actuated by tilting the joystick 64. In some circumstances, it is desired that the movement of the vehicle 12 and/or the attachment 32 be finely adjustable. Accordingly, the movement throttle slider 84 may be used to increase or decrease the sensitivity of movement caused by tilting of the joystick 64. For example, when it is desired to move the vehicle 12 close to an object, such as a wall, without hitting the object, the vehicle 12 may be brought within a few meters of the object using the regular coarse settings of the movement systems actuated by tilting the joystick 64. Then, the movement throttle slider 84 may be adjusted so that further tilting of the joystick 64 may result in only very small movements of the vehicle 12. This allows the operator to make small adjustments in the position of the vehicle 12, while still retaining the option to make larger and faster movements of the vehicle 12 when fine adjustments are not necessary. The movement slider 84 may be a slider switch that may be actuatable by the user, without letting go of the joystick 64.

It will be appreciated that a movement throttle slider may also be provided on the joystick 66 in order to provide the ability to make fine adjustments in the positioning of the accessory 32.

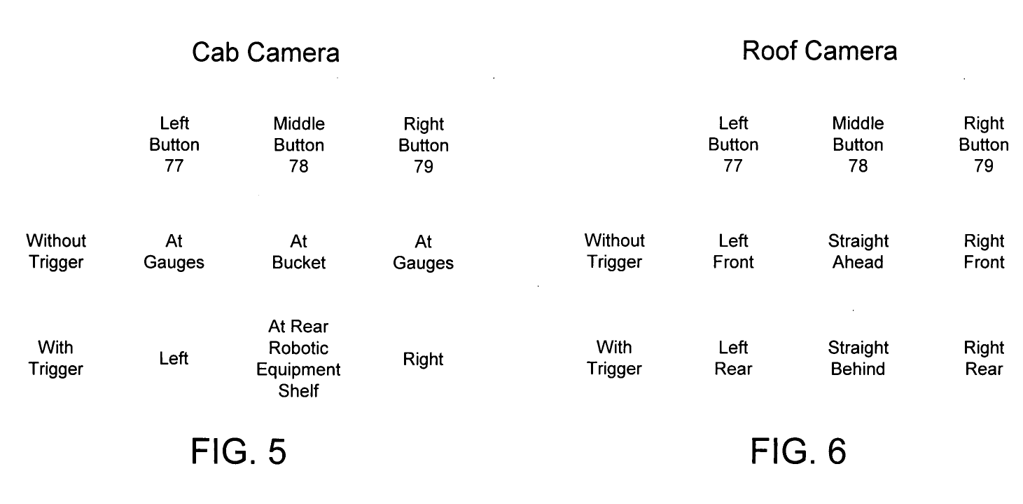

FIG. 5 illustrates an example of the preset configurations of the cab camera 38 that may be available from suitable actuation of the camera preset buttons 77-79. By pressing the camera preset buttons 77-79, selectively also depressing or not depressing the trigger 80, the cab camera 38 may be directed to the left, to the right, to the rear, at the bucket or other attachment or accessory 32, or at gauges of the vehicle 12.

FIG. 6 illustrates the preset configurations of the roof camera 36 that may be available by suitable actuation of a camera preset buttons and trigger on the joystick 66. As shown in FIG. 6, suitable movement of the roof camera preset hat switch may cause the roof camera to be directed straight ahead, straight behind, or at angles of about 45 degrees to the left or right of these directions.

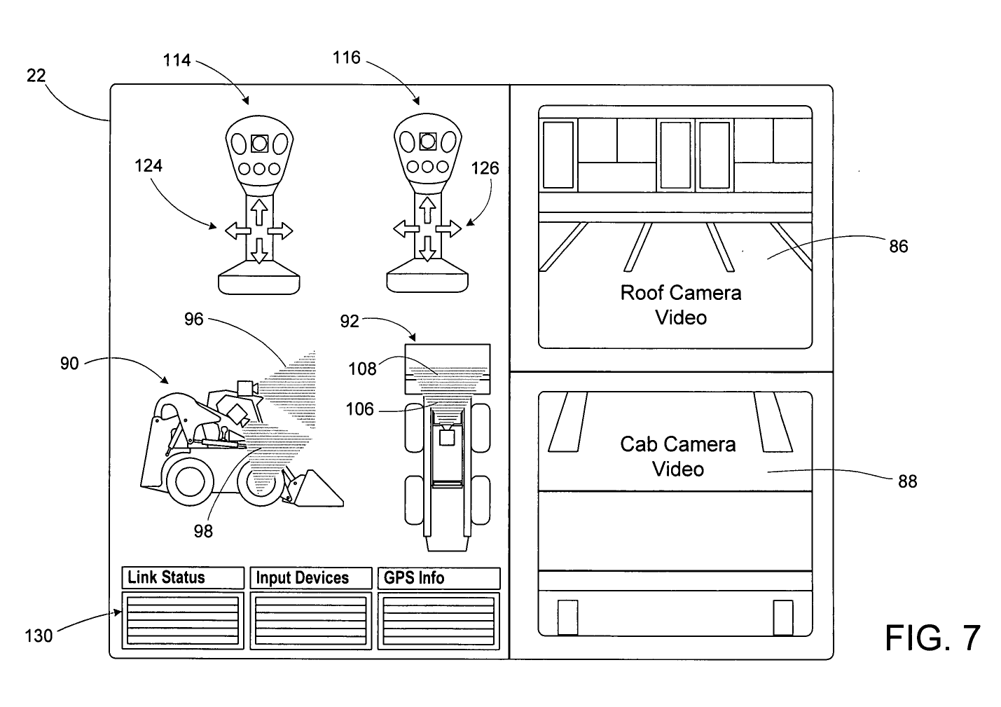

FIG. 7 illustrates an example of one view that may be shown on the display 22. The view on the display 22 shown in FIG. 7 provides a wide variety of information to the operator of the remote control system 10, enabling the operator to visually obtain many points of information with regard to the environment and operation of the vehicle 12. The view in FIG. 7 shows a roof camera view 86 from the roof camera 36, and a cab camera view 88 from the cab camera 38.

The direction and amount of zoom in the cameras 36 and 38 are illustrated graphically in the camera position illustrations 90 and 92. The illustrations 90 and 92 show graphic illustrations of the direction and amount of zoom of the cameras 36 and 38, relative to respective side and top views of the vehicle 12. In the side image 90, the angles of tilt of the cameras 36 and 38 are illustrated by relative tilt of triangles 96 and 98 that appear to emanate from representation of the respective cameras 36 and 38. The pan angles of the cameras 36 and 38 are illustrated by position of triangles 106 and 108 in the top image 92. The size of the triangles 96, 98, 106, and 108 graphically illustrate the amounts of zoom in the corresponding cameras 36 and 38. A smaller triangle graphically indicates a greater amount of zoom for the corresponding camera, and a narrower field of view (FOV). A larger triangle graphically indicates a decrease in amount of zoom for the corresponding camera, and a wider field of view (FOV). To aid in differentiating between the triangles 96 and 98, the triangles 96 and 98 may be displayed in different colors, or in another visually different manner.

Control position images 114 and 116 may be used to indicate the actuation of some or all of the parts of the respective hand controls 24 and 26. For example, tilting of the joysticks 64 and 66 may be indicated by highlighting, or changing or adding colors to various arrows 124 and 126 in the images 114 and 116. Actuation of the various camera-control switches may also be indicated in the images 114 and 116, by any of a variety of visual indicators provided on corresponding portions of the control indicators 114 and 116.

Status of various parts of the vehicle 12 and/or the control system 10 may be indicated in a status region 130 of the display 22. This region may display status and/or information regarding linking status and/or operability of various components of the vehicle 12; the speed of the vehicle 12; latitude, longitude, location, and/or altitude of the vehicle 12; and/or configuration of the input devices, such as the hand controls 24 and 26.

It will be appreciated that the large amount of visual information supplied in the display configuration that is shown in FIG. 7 provides multiple items of important information, in a configuration that is easily accessible and understandable by an operator of the remote control system 10. By having a large amount of such information readily accessible, remote control of the vehicle 12 is thereby enhanced.

It will be appreciated that the display shown in FIG. 7 is only one of a large variety of suitable visual displays that may be used for displaying information from the vehicle 12, and/or from portions of the control system 10. The information shown in FIG. 7 may be configured in any of a variety of different ways, and may be presented in any of a variety of suitable manners. Additional information may be provided, or some of the information shown may be omitted from a suitable display.

It will be appreciated that suitable computer software may be configured to run on the computer processor 41, for generation of the display shown in FIG. 7. Many of the details of such computer software are generally known to those skilled in the art, and therefore need not be repeated in detail here. Suitable computer software may be configured for receiving information input from the various inputs described above, for example, the hand controls 24 and 26, the keyboard 42, and/or the mouse 44. Such software may be configured to send and receive suitable signals via the control unit transceiver 28, and to generate views such as that of FIG. 7, on the display 22.

The remote control system 10 has been described above as operating through use of software on a single computer 20. The computer system 20 may utilize any of a variety of suitable operating systems, for example, including graphical user interface systems such as WINDOWS. Software for executing the above-described functions on the computer system 20 may be written in any of a variety of suitable computer systems.

The software may be executed on a single computer, for instance on a single processor. Alternatively, execution of the software and/or the functions described above may occur in multiple computers, for instance linked to one another over a network, such as the Internet, wide area networks (WANs), local area networks (LANs) and/or other suitable networks, etc., or any combination of two or more such networks. The computer 20 may have suitable components, such as network cards, modems, or other such communication devices, for communicating over a network.

Software that contains processing logic for accomplishing the above-described functions may be embodied in any suitable computer-readable medium for use by or in connection with an instruction execution system such as a computer/processor based system or other system that can fetch or obtain the logic from the computer-readable medium and execute the instructions or action statements contained therein. In the context of this document, a “computer-readable medium” may be any suitable medium that can contain, store, or maintain the processing logic for use by or in connection with an instruction execution system. The computer-readable medium may include any one of many physical media, such as, for example, electronic, magnetic, optical, electromagnetic, infrared, or semiconductor media. More specific examples of suitable computer-readable media include, but are not limited to, portable magnetic computer diskettes such as floppy diskettes or hard drives, random access memory (RAM), read-only memory (ROM), erasable-programmable read-only memory, or portable compact disks.

The remote control system 10 described herein may allow for intuitive hands-on remote operation of the vehicle 12. It will be appreciated that remote operation of a vehicle may be desirable in any of a variety of hazardous situations, such as when dealing with explosives or dangerous environments, such as in environments possibly contaminated by dangerous chemicals or biological agents. Other possible situations suitable for using the remote control system include situations in the presence of hostile, armed persons, such as in combat and in hostage situations. By providing a remote control system 10 that enables a user to receive much visual information via display, and to operate many aspects while maintaining hands on the hand controls 24 and 26, and attention of the operator on the visual display 22, remote operation of the vehicle 12 may be enhanced.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A control system for remotely controlling a vehicle comprises:
hand controls for remotely controlling movement of the vehicle, and for controlling one or more cameras mounted on the vehicle; and
a display for displaying output from the one or more cameras;
wherein the hand controls are configured to be moved to control movement of the vehicle;
wherein the hand controls include camera-control switches for controlling the one or more cameras;
wherein the hand controls are configured to receive both hands of a user; and
wherein the camera-control switches are operable by the user with the user removing the hands from the hand controls.

2. The system of claim 1, wherein the hand controls include a pair of joystick controllers for controlling movement of the vehicle.

3. The system of claim 2, wherein movement of one of the joystick controllers controls overall movement of the vehicle, and movement of the other of the joysticks controls movement of one or more accessories on the vehicle.

4. The system of claim 3, wherein the accessories include a liftable and tiltable bucket.

5. The system of claim 1, wherein the camera-control switches include preset switches that adjust one or more of the cameras to preset positions.

6. The system of claim 1, wherein the camera-control switches include one or more zoom switches for zooming one or more of the cameras in or out.

7. The system of claim 1, wherein the camera-control switches include one or more pan switches for panning one or more of the cameras.

8. The system of claim 1, wherein the camera-control switches include one or more tilt switches for tilting one or more of the cameras.

9. The system of claim 1, wherein the camera-control switches include buttons.

10. The system of claim 1, wherein the camera-control switches include hat switches.

11. The system of claim 1, wherein the hand controls includes a throttle that controls response sensitivity of movement of the vehicle to movements of the hand controls.

12. The system of claim 11, wherein the throttle is a slider on one of the hand controls.

13. The system of claim 1, wherein the display also shows an indication of the positions of the hand controllers.

14. The system of claim 1, wherein the display also shows one or more representations graphically illustrating the orientation of the one or more cameras relative to the vehicle.

15. A method of remotely controlling a vehicle, the method comprising:
controlling movement of the vehicle and one or more accessories of the vehicle using hand controls of a remote control system; and
controlling positioning of one or more cameras of the vehicle using camera switches on the hand controls.

16. The method of claim 15, wherein the camera switches include a camera preset switch, and wherein actuating the camera preset switch allows selecting one or more predetermined camera orientations.

17. The method of claim 15, wherein the camera switches include a camera preset switch, and wherein actuating the camera preset switch allows selecting one or more predetermined camera orientation/zoom combinations.

18. The method of claim 15, wherein the hand controls include a pair of joystick controllers, and wherein the controlling movement includes tilting one or both joysticks of the joystick controllers.

19. The method of claim 18, wherein the controlling movement includes tilting one of the joysticks to control movement of the vehicle and tilting the other of the joysticks to control movement of at least one of the accessories.

20. The method of claim 15, wherein the controlling position of the cameras includes maintaining physical engagement of an operator with the hand controls.

21. The method of claim 15, further comprising displaying one or more images from the camera on a display that is part of the remote control system.

22. The method of claim 21, further comprising displaying on the display one or more graphical indicators of camera position of the one or more cameras.

23. The method of claim 15, further comprising controlling response sensitivity of the hand controls.

24. The method of claim 23, wherein the controlling response sensitivity includes moving respective sliders on the hand controls.
